(19) United States
(12) Patent Application Publication
(10) Pub. No.: US 2024/0430714 A1
(43) Pub. Date: Dec. 26, 2024

(54) REDUCING SMALL CELL DOWNTIME DURING INTERMITTENT FAILURES

(71) Applicant: Radisys Corporation, Hillsboro, OR (US)

(72) Inventors: Vaibhav Kumar KALA, Noida (IN); Gaurav CHANANA, Gurugram (IN); Rajesh JAIN, Gurugram (IN); Rajiv GUPTA, Gurugram (IN)

(21) Appl. No.: 18/749,261

(22) Filed: Jun. 20, 2024

Related U.S. Application Data
(60) Provisional application No. 63/509,701, filed on Jun. 22, 2023.

(51) Int. Cl. H04W 24/04; H04W 28/04; H04W 76/19

(52) U.S. Cl. CPC H04W 24/04; H04W 28/04; H04W 76/19

(57) ABSTRACT

Disclosed is a gNB or O-RAN for handling intermittent SA-service only failures. In some embodiments, the gNB or O-RAN are configured to detect a service outage when an NG link is down; stop broadcasting SIB1; change ssb-SubcarrierOffset (Kssb) in a MIB transmission; and change an SSB location to prevent incoming handovers from a neighbor cell.

### CROSS-REFERENCE TO RELATED APPLICATIONS

This application claims priority benefit of U.S. Provisional Patent Application No. 63/509,701, filed Jun. 22, 2023, which is hereby incorporated by reference in its entirety.

### TECHNICAL FIELD

This application relates generally to providing 5G networks having standalone access (SA) and non-standalone access (NSA) modes, and in particular, to maintaining NSA service for dual mode devices in response to a failure related to SA service.

### BACKGROUND INFORMATION

Wireless mobile communication technology uses various standards and protocols to transmit data between a base station and a wireless mobile device. Wireless communication system standards and protocols may include the 3rd Generation Partnership Project (3GPP) long term evolution (LTE) (e.g., 4G) or new radio (NR) (e.g., 5G); the Institute of Electrical and Electronics Engineers (IEEE) 802.16 standard, which is commonly known to industry groups as worldwide interoperability for microwave access (WiMAX); and the IEEE 802.11 standard for wireless local area networks (WLAN), which is commonly known to industry groups as Wi-Fi®.

In 3GPP radio access networks (RANs) in LTE systems, the base station may include a RAN node such as an Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with a wireless communication device, known as user equipment (UE). In fifth generation (5G) wireless RANs, RAN Nodes may include a 5G Node, NR node (also referred to as a next-generation Node B or gNodeB (gNB)).

RANs use a radio access technology (RAT) to communicate between the RAN node and UE. RANs may include global system for mobile communications (GSM), enhanced data rates for GSM evolution (EDGE) RAN (GERAN), Universal Terrestrial Radio Access Network (UTRAN), and/or E-UTRAN, which provide access to communication services through a core network. Each of the RANs operates according to a specific 3GPP RAT. For example, the GERAN implements GSM and/or EDGE RAT, the UTRAN implements universal mobile telecommunication system (UMTS) RAT or other 3GPP RAT, the E-UTRAN implements LTE RAT, and NG-RAN implements 5G RAT. In certain deployments, the E-UTRAN may also implement 5G RAT. As used herein, the term “NG-RAN node” (or simply NG-RAN) may refer to a RAN node that operates in an NR or 5G system and the term “E-UTRAN node” or the like may refer to a RAN node that operates in an LTE or 4G system (e.g., an eNB).

In a network with multiple RANs, an eNB can be designated as the master eNB (MeNB), which coordinates with other gNBs, known as secondary gNBs (SgNBs), to provide seamless coverage and connectivity in areas with overlapping coverage. This is especially relevant in advanced network configurations like dual connectivity, where a mobile device can simultaneously connect to both 4G LTE and 5G NR networks for improved performance and reliability. In such scenarios, the MeNB is responsible for managing the control plane, while the SgNBs handle the user-plane data. In 5G networks, dual mode 5G devices can operate in both 4G and 5G networks, and they can use either 4G or 5G for voice and data services. Dual mode devices are backward compatible with 4G, which means that they can fall back to 4G if 5G coverage is not available.

One type of dual connectivity is E-UTRA-NR Dual Connectivity (EN-DC), in which a UE is connected to one eNB that acts as a master node and one gNB (en-gNB) that acts as a secondary node. The eNB is connected to the EPC via the S1 interface and to the en-gNB via the X2 interface. The en-gNB might also be connected to the EPC via the S1-U interface and other en-gNBs via the X2-U interface.

Non-standalone access (NSA) is a 5G deployment architecture that relies on the existing 4G infrastructure for some of its functions. In NSA mode, the 5G network uses the 4G network for functions such as control signaling and mobility management. This means that the 5G network can provide faster data speeds than 4G but may not provide all the features and capabilities of a standalone 5G network.

Standalone access (SA) is another deployment architecture for 5G networks that is different from NSA. In SA mode, the 5G network operates independently of the existing 4G infrastructure, which means that it does not rely on 4G for any of its functions. In an SA 5G network, both the control plane and the user plane functions are handled by the 5G network. This means that the 5G network provides end-to-end connectivity and supports all the features and capabilities of a standalone 5G network. SA 5G networks are designed to provide higher data rates, lower latency, and better reliability than NSA 5G networks. One advantage of SA 5G networks is that they can support advanced use cases and applications that require low latency and high reliability, such as autonomous vehicles, industrial automation, and remote surgery. SA 5G networks are also expected to be more efficient in terms of network resource utilization and energy consumption compared to NSA 5G networks. The latest 5G cellular networking standards support new use cases such as enhanced mobile broadband (eMBB), ultra-reliable low latency communications (URLLC), massive machine-type communications (mMTC), cellular vehicle to anything (CV2X) communications and several others that will benefit the industrial revolution into the next decade.

Mobile network operators will seek to deliver unique service-level agreements (SLAs) to their customers based on specific use cases and their end-to-end emerging cloud-native network infrastructure deployments while supporting interworking with other legacy and emerging access technologies. Ubiquitous availability of 5G services in mid and high bands is expected to be realized through the deployment of small cells. Additionally, for private/enterprise and vertical markets (e.g., industrial, energy, agriculture, etc.), small cell-based 5G RAN solutions are likely to be the most prevalent. Currently, as operators transition from NSA to SA-only 5G networks, 5G RAN vendors are deploying concurrent NSA/SA mode solutions to service both types of UE (those that support SA only or NSA only), and this trend is expected to continue for some time.

### SUMMARY OF THE DISCLOSURE

In situations where intermittent or short-term failures affect SA service, such as when gNB connectivity to an AMF is interrupted, the typical approach is to completely stop the gNB cell until the issue is resolved. This approach, however, has drawbacks including increased downtime for the cell service and an inability to serve NSA UEs. Conversely, allowing the cell to continue transmitting during intermittent SA-only failures can result in increased handover failures, decreased mobility key performance indicators (KPIs), and increased network load due to excessive signaling.

To address these challenges, this document proposes solutions that reduce cell downtime during intermittent outages and enable 5G services to continue for NSA UEs in the event of an SA service failure. This is achieved by making the cell inoperative for SA cell service without stopping cell transmission completely, controlling incoming UE mobility from the gNB itself, and enabling services to NSA UEs in the case of concurrent NSA/SA.

This solution offers several benefits, such as reduced 5G service downtime for SA UEs without impacting mobility KPIs or increasing network load, increased resiliency and reliability, and potential value-add for CU and DU software for operators deploying small cell and private 5G solutions.

As the demand for high throughput and reliable connectivity continues to increase, the described solutions provide a desirable approach for operators looking to enhance their network performance and customer experience. By reducing downtime and enabling continued services for NSA UEs, the disclosed techniques improve the overall quality of service and customer satisfaction.

Additional aspects and advantages will be apparent from the following detailed description of embodiments, which proceeds with reference to the accompanying drawings.

### BRIEF DESCRIPTION OF THE DRAWING FIGURES

To easily identify the discussion of any particular element or act, the most significant digit or digits in a reference number refer to the figure number in which that element is first introduced.

FIG. 1 is a block diagram of RAN architectures in accordance with one embodiment.

FIG. 2 is a block diagram of a wireless communications system, according to one embodiment.

FIG. 3 is a block diagram of a 5G system service based architecture in accordance with one embodiment.

FIG. 4 is a block diagram of a cellular network showing signaling in response to a service disruption in accordance with one embodiment.

FIG. 5 is a block diagram of a cellular network showing reduce signaling in response to a service disruption in accordance with one embodiment.

FIG. 6 is a block diagram showing a frequency domain shift in a synchronization signal block (SSB) in accordance with one embodiment.

FIG. 7 is a block diagram showing a time domain shift in an SSB in accordance with one embodiment.

FIG. 8A1, FIG. 8A2 and FIG. 8B are, respectively, an ASN definition and corresponding table description of a MeasurementTimingConfiguration IE, according to 3GGP TS 38.331 v 17.0.0.

FIG. 9A and FIG. 9B are, respectively, an ASN definition and corresponding table description of an SSB-MTC IE, according to 3GGP TS 38.331 v 17.0.0.

FIG. 10A and FIG. 10B show, respectively, upper and lower portions of a message sequence diagram for signaling in response to a service disruption in accordance with one embodiment.

FIG. 11 is a message sequence diagram for fault-handling signaling in response to a service disruption in accordance with one embodiment.

FIG. 12 is a message sequence diagram for recovery-handling signaling in response to a service disruption in accordance with one embodiment.

FIG. 13 is a message sequence diagram for fault-handling signaling using X2/Xn/F1 in response to a service disruption in accordance with one embodiment.

FIG. 14 is a message sequence diagram for fault-handling signaling using X2/Xn/F1 in response to a service disruption with an E2 setup already established in accordance with one embodiment.

FIG. 15 is a flow diagram of a process for handling intermittent SA-service only failures, in accordance with one embodiment.

FIG. 16 is a block diagram of computing components for performing the disclosed procedures, in accordance with one embodiment.

### DETAILED DESCRIPTION OF EMBODIMENTS

During intermittent or short-term failures affecting SA service (such as gNB connectivity to an AMF going down intermittently), the gNB cell is usually stopped completely until recovery from the failure occurs. This presents the following issues. Bringing up the cell from a completely stopped state after failure recovery can take several minutes, resulting in increased overall cell service downtime. Furthermore, although the gNB cannot provide SA service during such failures, it can still provide 5G service to NSA UE if the cell is not completely shut down. Thus, in concurrent NSA/SA mode gNB, bringing down the cell would prevent the gNB from serving the UEs, even though NSA UEs can still be served.

On the other hand, an attempt at barring the cell but allowing it to transmit during intermittent SA-only failures (i.e., attempting to reduce the service downtime) would result in increased handovers failures. This deteriorates the overall mobility KPIs while at the same time increasing the network load because of measurement reports being sent by UEs and handover requests generated from the peer gNBs. For instance, if the gNB cell is allowed to continue transmitting with cell-barred during intermittent SA-only failures, the gNB in SA mode cannot control incoming mobility from peer gNB without a handshake of mobility parameters, which may not be possible during some failures (e.g., backhaul transport connectivity loss). In small cell deployments where multiple neighbors per gNB are affected due to similar failures, excessive signaling during failure recovery can occur. If the gNB continues broadcasting the cell, UEs connected to peer gNB will keep reporting this cell as a neighbor.

This document discusses embodiments related to UE mobility in access stratum. The disclosed techniques reduce cell downtime during intermittent outages and enable 5G services to continue for NSA UE(s) in the case of an SA service failure. This reduces the cell service downtime during short-term outages by making the cell inoperative for cell service without the need to stop the cell transmission completely. This is done by restricting the cell for the incoming mobility of the UE from the gNB itself without the involvement of the peer gNB or MeNB. Additionally, the embodiments allow, in case of concurrent NSA/SA, the services to NSA UE to continue if the failure is related to SA service only.

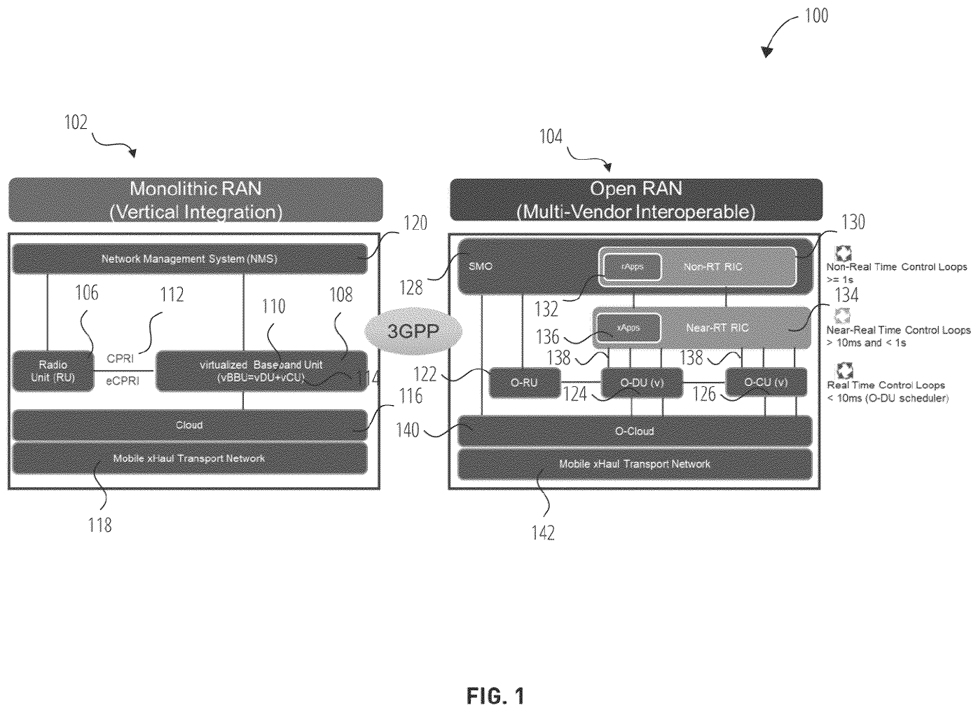

FIG. 1 shows a comparison between two different types of NR-RANs 100. Specifically, NR-RANs 100 include a monolithic RAN architecture 102 and an Open RAN (O-RAN) 104. These are described as follows.

Monolithic RAN architecture 102 includes a radio unit (RU) 106 and a virtual baseband unit (vBBU) 108. RU 106 is the part of the network that is physically closest to an end user and is responsible for the radio transmission and reception. RU 106 is typically located on a tower or other high structure. RU 106 exchanges data with a distributed unit (DU) 110 over a common public radio interface (CPRI) 112 or an enhanced CPRI (eCPRI). DU 110 is the part of the network that is responsible for processing and forwarding data between RU 106 and a central unit (CU) 114. In some embodiments, a DU may be located either near RU 106 or centrally (as in the case of vDU). CU 114 is the part of the network that is responsible for the control plane functions, such as managing the network and allocating resources. CU 114 is typically located in a central location, such as a data center. In some embodiments, RU, DU, and CU may be implemented in a gNB (i.e., gNB-RU, gNB-DU, and gNB-CU).

VBBU 108 is a software-based implementation of the baseband processing functions in a wireless network, typically as part of a cloud-RAN (CRAN) or virtualized RAN architecture. In a traditional RAN, a BBU is a hardware-based component responsible for processing baseband signals and managing radio resources. In a virtualized RAN, baseband processing functions are decoupled from the hardware and implemented as virtualized software components running on commercial off-the-shelf (COTS) hardware or a cloud 116 infrastructure. VBBU 108 can be dynamically scaled, allowing network operators to allocate resources more efficiently based on traffic demands and network conditions. In this example, vBBU 108 includes a distributed unit (DU) and a central unit (CU), both of which are virtualized (i.e., vDU and vCU).

Monolithic RAN architecture 102 shows a mobile xhaul transport network 118 (where “x” may be fronthaul, midhaul, or backhaul). Examples of mobile xhaul transport network 118 include fiber optic (e.g., software-defined passive optical network (SD-PON)), data over cable service interface specification (DOCSIS), microwave, and combinations and other types of transport networks.

In terms of a management layer, monolithic RAN architecture 102 shows a network management system (NMS) NMS 120. NMS 120 is a set of tools and applications used by network operators to monitor, manage, and maintain monolithic RAN architecture 102. NMS 120 provides a centralized platform for network operators to control and optimize the performance of the radio access network, ensuring efficient operation, high reliability, and optimal user experiences.

In contrast to monolithic RAN architecture 102, O-RAN architecture 104 is a disaggregated approach, with open interfaces across the RAN, transport, cloud, and management layers. O-RAN is an evolution of the NG-RAN architecture, first introduced by the GSMA's 3GPP in its release 15 (5G version 1) technical specification TS 38.401. The O-RAN Alliance formed to undertake the advancement of NG-RAN philosophies, expanding on the scope of what was originally outlined by the 3GPP. O-RAN architectures adopt software defined network (SDN) and network function virtualization (NFV), while supporting enhanced network analytics and AI/ML enabled smart decision making. In the example of FIG. 1, O-RAN architecture 104 includes an O-RAN RU (O-RU) 122, an O-RAN DU (O-DU) 124, and an O-RAN CU (O-CU) 126. O-DU 124 or O-CU 126 are virtualized, in some embodiments.

A service management and orchestration (SMO) 128 for O-RAN architecture 104 is a software component responsible for managing and controlling the services and resources provided by the network to the users. SMO 128 monitors the quality of service and ensures that the network is delivering the required services efficiently and effectively. It also provides real-time insights into network performance, enabling the network operator to make informed decisions about resource allocation and network optimization. SMO 128is a unified service management and orchestration layer that manages a service provider's 5G RAN, transport, and 5GC infrastructure equipment from multiple vendors. SMO 128 includes end-to-end (E2E) orchestration, RAN orchestration, and CN+transport orchestration, in some embodiments.

A non-real-time RAN intelligent controller (non-RT RIC) 130 of SMO 128 provides network intelligence and control functions, but operates outside of real-time constraints. Non-RT RIC 130 hosts rApps 132, which includes specialized microservices that do not require real-time processing, such as network planning, configuration management, and performance analysis. It provides network operators with valuable insights into network performance, resource utilization, and security, and enables them to make informed decisions about network configuration and resource allocation. Non-RT RIC 130 also terminates an O1 interface, which connects to every other RAN component for management and orchestration of network functionalities.

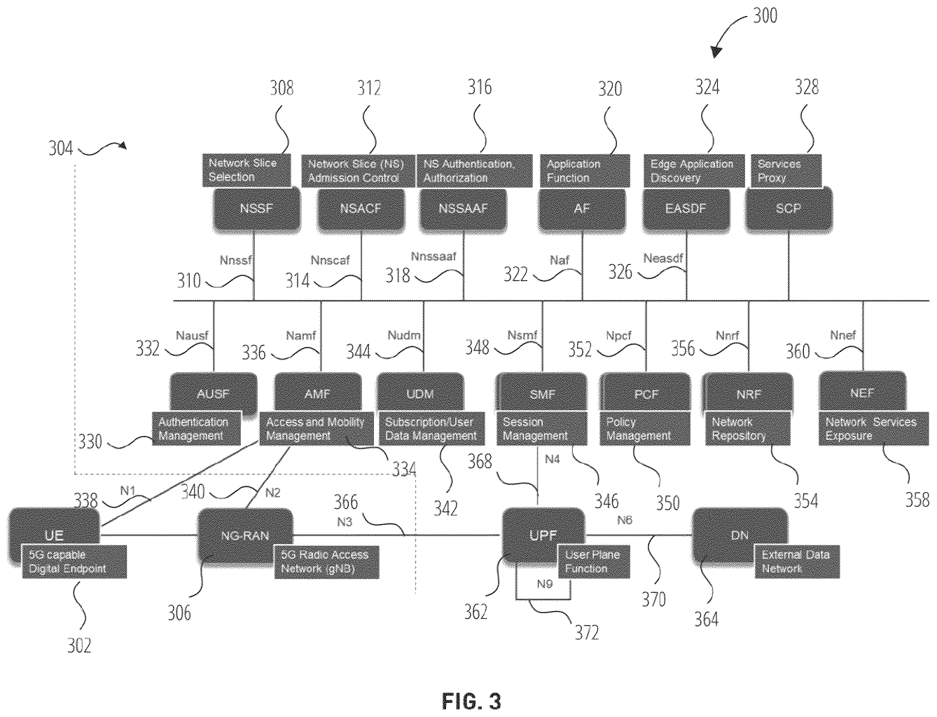

A near-RT RIC 134 hosts xApps 136, which in some examples configure near-RT RIC 134 to optimize radio spectrum efficiency and provide real-time radio network information and intelligence to a 5GC (FIG. 3). This enables the 5G network to make informed and automated decisions about network resources and configurations in real-time. Near-RT RIC 134 communicates via an E2 interface 138 with O-CU 126 and O-DU 124 to gather information about the network conditions and performance. It then processes this information and provides it to non-RT RIC 130 via an A1 interface, allowing the network to make real-time adjustments and optimizations to the network configuration.

In some embodiments, as defined in O-RAN's SMO framework, a network's O-CU 126 functions, O-DU 124 functions, and near-RT RIC 134 are defined as cloud-native virtualized functions which run on a cloud infrastructure referred to an O-cloud 140. O-cloud 140 is a cloud computing platform made up of the physical infrastructure nodes using O-RAN architecture 104. It also creates and hosts the various virtual network functions (VNFs) used by RICs and other infrastructure elements. Non-RT RIC 130 and SMO 128 connect to O-cloud 140 though an O2 interface.

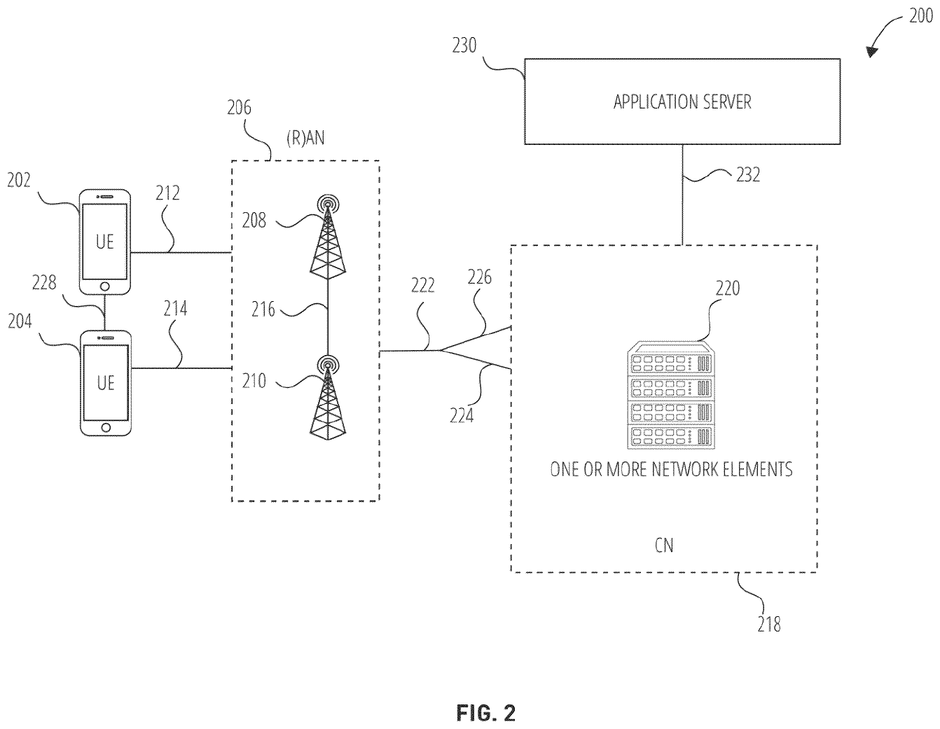

FIG. 2 illustrates an example architecture of a system 200 of a network, in accordance with various embodiments. The following description is provided for an example system 200 that operates in conjunction with the LTE system standards and 5G or NR system standards as provided by 3GPP technical specifications. However, the example embodiments are not limited in this regard and the described embodiments may apply to other networks that benefit from the principles described herein, such as future 3GPP systems (e.g., Sixth Generation (6G)), IEEE 802.16 protocols (e.g., WMAN, WiMAX, etc.), or the like.

As shown by FIG. 2, system 200 includes UE 202 and UE 204. In this example, UE 202 and UE 204 are illustrated as smartphones (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine-type-communication devices, M2M, IoT devices, and/or the like.

In some embodiments, UE 202 and/or UE 204 may be IoT UEs, which may comprise a network access layer designed for low-power IoT applications utilizing short-lived UE connections. An IoT UE may utilize technologies such as M2M or machine-type-communication for exchanging data with a machine-type-communication server or device via a PLMN, ProSe or D2D communication, sensor networks, or IoT networks. The machine-type-communication or machine-type-communication exchange of data may be a machine-initiated exchange of data. An IoT network describes interconnecting IoT UEs, which may include uniquely identifiable embedded computing devices (within the internet infrastructure), with short-lived connections. The IoT UEs may execute background applications (e.g., keep-alive messages, status updates, etc.) to facilitate the connections of the IoT network.

UE 202 and UE 204 may be configured to connect, for example, communicatively coupled, with an access node or radio access node (shown as (R)AN 206). In some embodiments, (R)AN 206 may be an NG-RAN or a 5G RAN, an E-UTRAN, or a legacy RAN, such as a UTRAN or GERAN. NG-RAN may refer to a (R)AN 206 that operates in an NR or 5G system, and E-UTRAN may refer to a (R)AN 206 that operates in an LTE or 4G system.

(R)AN 206 may include one or more AN nodes, such as RAN node 208 and RAN node 210, that enable connection 212 and connection 214. As used herein, the terms “access node,” “access point,” or the like may describe equipment that provides the radio baseband functions for data and/or voice connectivity between a network and one or more users. These access nodes may be referred to as BS, gNBs, RAN nodes, eNBs, NodeBs, RSUs, TRxPs, or TRPs, and so forth, and may comprise ground stations (e.g., terrestrial access points) or satellite stations providing coverage within a geographic area (e.g., a cell).

According to various embodiments, RAN node 208 or RAN node 210 may be implemented as one or more of a dedicated physical device such as a macrocell base station, and/or a low-power base station for providing femtocells, picocells, or other like cells having smaller coverage areas, smaller user capacity, or higher bandwidth compared to macrocells.

In some embodiments, all or parts of RAN node 208 or RAN node 210 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by individual RAN nodes (e.g., RAN node 208 or RAN node 210); a MAC/PHY split wherein RRC, PDCP, RLC, and MAC layers, are operated by the CRAN/vBBUP and the PHY layer is operated by individual RAN nodes (e.g., RAN node 208 or RAN node 210); or a “lower PHY” split wherein RRC, PDCP, RLC, and MAC layers and upper portions of the PHY layer are operated by the CRAN/vBBUP and lower portions of the PHY layer are operated by individual RAN nodes. This virtualized framework allows the freed-up processor cores of the RAN node 208 or RAN node 210 to perform other virtualized applications.

In some implementations, an individual RAN node may represent individual gNB-DUs that are connected to a gNB-CU via individual F1 interfaces (not shown in FIG. 2). In these implementations, the gNB-DUs may include one or more remote radio heads or RFEMs, and the gNB-CU may be operated by a server that is located in (R)AN 206 (not shown) or by a server pool in a similar manner as the CRAN/vBBUP. Additionally, or alternatively, one or more of RAN node 208 or RAN node 210 may be next-generation eNBs (ng-eNBs), which are RAN nodes that provide E-UTRA user plane and control plane protocol terminations toward UE 202 and UE 204, and are connected to a 5GC via an NG interface. In V2X scenarios one or more of RAN node 208 or RAN node 210 may be or act as RSUs.

RAN node 208 and/or RAN node 210 may terminate the air interface protocol and may be the first point of contact for UE 202 and UE 204. In some embodiments, RAN node 208 and/or RAN node 210 may fulfill various logical functions for (R)AN 206 including, but not limited to, RNC functions such as radio bearer management, uplink and downlink dynamic radio resource management and data packet scheduling, and mobility management.

RAN node 208 or RAN node 210 may be configured to communicate with one another via interface 216 in case of NSA deployment. In embodiments where system 200 is an LTE anchored system (e.g., when CN 218 is an EPC), interface 216 may be an X2 interface. The X2 interface may be defined between two or more RAN nodes (e.g., one eNB as an anchor for UE connection and the other being gNB acting as a secondary RAN node for capacity expansion and the like) that connect to an EPC. In some implementations, the X2 interface may include an X2 user plane interface (X2-U) and an X2 control plane interface (X2-C). The X2-U may provide flow control mechanisms for user data packets transferred over the X2 interface, and may be used to communicate information about the delivery of user data between the anchor eNB and secondary gNB. For example, the X2-U may provide specific sequence number information for user data transferred from a MeNB to an SgNB; information about successful in sequence delivery of PDCP PDUs to UE 202 from an SgNB for user data; information of PDCP PDUs that were not delivered to UE 202; information about a current minimum desired buffer size at the SgNB for transmitting to the UE user data; and the like. The X2-C may provide intra-LTE access mobility functionality, including context transfers from source to target eNBs, user plane transport control, etc.; load management functionality; as well as inter-cell interference coordination functionality.

In embodiments where system 200 is a 5G or NR system (e.g., when CN 218 is an 5GC), interface 216 may be an Xn interface. The Xn interface is defined between two or more RAN nodes (e.g., two or more gNBs and the like) that connect to 5GC, between a RAN node 208 (e.g., a gNB) connecting to 5GC and an eNB, and/or between two eNBs connecting to 5GC (e.g., CN 218). In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 102 in a connected mode (e.g., CM-CONNECTED) including functionality to manage the UE mobility for connected mode between one or more RAN node 208 or RAN node 210. The mobility support may include context transfer from an old (source) serving RAN node 208 to new (target) serving RAN node 210; and control of user plane tunnels between old (source) serving RAN node 208 to new (target) serving RAN node 210. A protocol stack of the Xn-U may include a transport network layer built on Internet Protocol (IP) transport layer, and a GTP-U layer on top of a UDP and/or IP layer(s) to carry user plane PDUs. The Xn-C protocol stack may include an application layer signaling protocol (referred to as Xn Application Protocol (Xn-AP)) and a transport network layer that is built on SCTP. The SCTP may be on top of an IP layer, and may provide the guaranteed delivery of application layer messages. In the transport IP layer, point-to-point transmission is used to deliver the signaling PDUs. In other implementations, the Xn-U protocol stack and/or the Xn-C protocol stack may be same or similar to the user plane and/or control plane protocol stack(s) shown and described herein.

(R)AN 206 is shown to be communicatively coupled to a core network in this embodiment, CN 218. CN 218 may comprise one or more network elements 220, which are configured to offer various data and telecommunications services to customers/subscribers (e.g., users of UE 202 and UE 204) who are connected to CN 218 via (R)AN 206. The components of CN 218 may be implemented in one physical node or distributed across separate physical nodes including components to read and execute instructions from a machine-readable or computer-readable medium (e.g., a non-transitory machine-readable storage medium). In some embodiments, NFV may be utilized to virtualize any or all of the above-described network node functions via executable instructions stored in one or more computer-readable storage mediums (described in further detail below). A logical instantiation of CN 218 may be referred to as a network slice, and a logical instantiation of a portion of CN 218 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

In embodiments, CN 218 may be a 5GC. As described in 3GPP TS 23.501, 5G CN 218 includes an access and mobility management function (AMF), a user plane function (UPF), a session management function (SMF), an authentication server function (AUSF), a network exposure function (NEF), a unified data management (UDM), a unified data repository (UDR), a short message service function (SMSF), a non-3GPP interworking function (N3IWF), a policy control function (PCF), an NF repository function (NRF), a network slice selection function (NSSF), an application function (AF), or other 5G core network functions. A charging function (CHF) introduced in the 5G system architecture allows charging services to be offered in connection with an operations support system and a business support system (OSS/BSS).

(R)AN 206 may be connected with CN 218 via an NG interface 222. In embodiments, NG interface 222 may be split into two parts, an NG user plane (NG-U) interface 224, which carries traffic data between RAN node 208 or RAN node 210 and a UPF, and an NG control plane (NG-C) interface 226, which is a signaling interface between RAN node 208 or RAN node 210 and AMFs.

In embodiments, CN 218 may be a 5G CN, while in other embodiments, CN 218 may be an EPC). Where CN 218 is an EPC, (R)AN 206 may be connected with CN 218 via an S1 interface 222. In embodiments, S1 interface 222 may be split into two parts, an S1 user plane (S1-U) interface 224, which carries traffic data between RAN node 208 or RAN node 210 and S-GW, and an S1-MME control plane interface 226, which is a signaling interface between RAN node 208 or RAN node 210 and MMEs.

FIG. 3 shows a 5G system service based architecture 300, according to one embodiment. 5G system service based architecture 300 includes the radio base stations, antennas, and wireless technologies (such as massive MIMO and beamforming) that enable communication between user equipment (UE) UE 302 (like smartphones and IoT devices) and a 5G core network (5GC) 304.

On a right side of the dashed line are network functions and interfaces for 5GC 304. 5GC 304 is a cloud-native, service-based architecture that enables flexible and scalable network functions in 5G. 5GC 304 includes network functions (described below) configured to offer various data and telecommunications services to customers/subscribers (e.g., users of UE 302) connected to 5GC 304 via an NG-RAN 306. The components of 5GC 304 may be implemented in one physical node or distributed across separate physical nodes including components to read and execute instructions from a machine-readable or computer-readable medium (e.g., a non-transitory machine-readable storage medium). In some embodiments, NFV may be utilized to virtualize any or all of the above-described network node functions via executable instructions stored in one or more computer-readable storage mediums (described in further detail below). A logical instantiation of 5GC 304 may be referred to as a network slice, and a logical instantiation of a portion of 5GC 304 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more 5GC components/functions. In the example of FIG. 3, 5GC 304 includes the following network functions and corresponding interfaces.

A network slice selection function (NSSF) 308 is responsible for selecting the appropriate network slice instance for a user based on subscription information, service requirements, and other factors. It helps allocate resources efficiently and manage network slices. Nnssf interface 310 is used to communicate network slice selection information and assistance data.

A network slice access control function (NSACF) 312 monitors and controls the number of registered UEs per network slice and/or the number of PDU sessions. Nnscaf interface 314 is the corresponding interface.

A network slice selection assistance function (NSSAAF) 316 creates slice authentication context for UE 302 and starts the slice-specific authentication and authorization procedure. Nnssaaf interface 318 is the corresponding interface.

An application function (AF) 320 is an external application or service that interacts with 5GC 304. It can request network resources, provide traffic steering rules, or request QoS (Quality of Service) for specific applications. Naf interface 322 it is used for AF 320 to request policy control, QoS, or network resource information from a PCF or to interact with the network through an NEF (described below).

An edge application service discovery function (EASDF) 324 supports the session breakout connectivity model. EASDF 324 acts as a domain name system (DNS) resolver to UE 302 and can complement the DNS queries with UE location-related information. This enables the DNS system to resolve to application servers close to the UE location. Neasdf interface 326 is the corresponding interface.

A service communication proxy (SCP) 328 is allows the control plane network to handle and prioritize massive numbers of requests in real time. SCP 328 provides a single point of entry for a cluster of network functions, once they have been successfully discovered by the NRF (described below). This allows SCP 328 to become the delegated discovery point in a data center, offloading the NRF from the numerous distributed services meshes that would ultimately make-up a network operator's infrastructure. Given the nature of SCP 328 as a proxy for communication between network functions, the interfaces it uses will depend on the specific network functions it connects.

An authentication server function (AUSF) 330 is responsible for user authentication and generating security keys. It verifies the user's credentials and ensures secure access to the network. Nausf interface 332 between AUSF 330 and AMF 334 is used to communicate authentication-related information and security key material.

An access and mobility management function (AMF) 334 manages access, mobility, and connection for user devices. It is responsible for registration, connection establishment, and handovers between different access networks. Namf interface 336 is between AMF 334 and other core network functions, such as the NSSF, UDM, and SMF. It is used to exchange mobility, access, and session-related information. AMF 334 also has a N1 interface 338 with UE 302 and a N2 interface 340 with NG-RAN 306.

A unified data management (UDM) 342 stores and manages subscriber data, including authentication credentials, access profiles, and subscription information. It also provides this data to other network functions when needed. Nudm interface 344 is between UDM 342 and other core network functions, such as the AMF, AUSF, and PCF. It is used to communicate subscriber data, authentication credentials, access profiles, and policy information.

A session management function (SMF) 346 manages user sessions, establishes and maintains data connections, and enforces policy control rules. It also ensures the correct routing of data traffic between the user device and external networks. Nsmf interface 348 is between the SMF and other core network functions, such as the AMF, UPF, and PCF. It is used to exchange session, routing, and policy enforcement information.

A policy control function (PCF) 350 is responsible for making policy decisions, such as QoS and charging, based on subscription information and network conditions. It provides these decisions to other network functions for enforcement. Npcf interface 352 is between the PCF and other core network functions, such as the SMF, AF, and UDM. It is used for policy decision-making and to communicate policy rules and QoS information.

A network repository function (NRF) 354 maintains a repository of available network functions and their capabilities, enabling service discovery and load balancing among network functions. Nnrf interface 356 is between the NRF and other core network functions. It is used for service discovery, registration, and capability exposure among the network functions.

A network exposure function (NEF) 358 exposes 5G network capabilities and resources to third-party applications and services. It provides a standardized API for external entities to interact with the network. Nnef interface 360 is between the NEF and other core network functions, such as the AMF, SMF, and PCF. It is used to expose network resources, capabilities, and services to external applications and services through standardized APIs.

A user plane function (UPF) 362 is responsible for handling and forwarding user data traffic between UE 302 and external data networks (DN) 364, such as public internet, private networks, or other communication networks. UPF 362 performs various functions such as packet filtering, policy enforcement, and QoS management. A N3 interface 366, and N4 interface 368 and an N6 interface 370 connect UPF 362 to, respectively, NG-RAN 306, SMF 346, and DN 364. A N9 interface 372 is between two UPF's (i.e, the intermediate I-UPF and the UPF session anchor).

UE 302 may be a smartphones (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, networked or “smart” appliances, machine-type-communication devices, M2M, IoT devices, and/or the like. In some embodiments, UE 302 may be an IoT UE, which may comprise a network access layer designed for low-power IoT applications utilizing short-lived UE connections. An IoT UE may utilize technologies such as M2M or machine-type-communication for exchanging data with a machine-type-communication server or device via a PLMN, ProSe or D2D communication, sensor networks, or IoT networks. The M2M or machine-type-communication exchange of data may be a machine-initiated exchange of data. An IoT network describes interconnecting IoT UEs, which may include uniquely identifiable embedded computing devices (within the internet infrastructure), with short-lived connections. The IoT UEs may execute background applications (e.g., keep-alive messages, status updates, etc.) to facilitate the connections of the IoT network.

RANs use a radio access technology (RAT) to communicate between the RAN node and UE. NG-RAN 306 implements 5G RAT. In certain deployments, an E-UTRAN may also implement 5G RAT. Thus, NG-RAN is a term that encompasses both a 5G RAN and an evolved LTE RAN (eLTE RAN) as part of the 5G network architecture, designed to provide a unified and flexible radio access network that supports both 5G NR and 4G LTE technologies. As used herein, the term “NG-RAN node” (or simply NG-RAN) refers to a RAN node that operates in an NR or 5G system. In 5G wireless RANs, RAN nodes may include a 5G NR node (also referred to as a gNB). 5G RAN refers specifically to the radio access network that is part of the 5G network architecture.

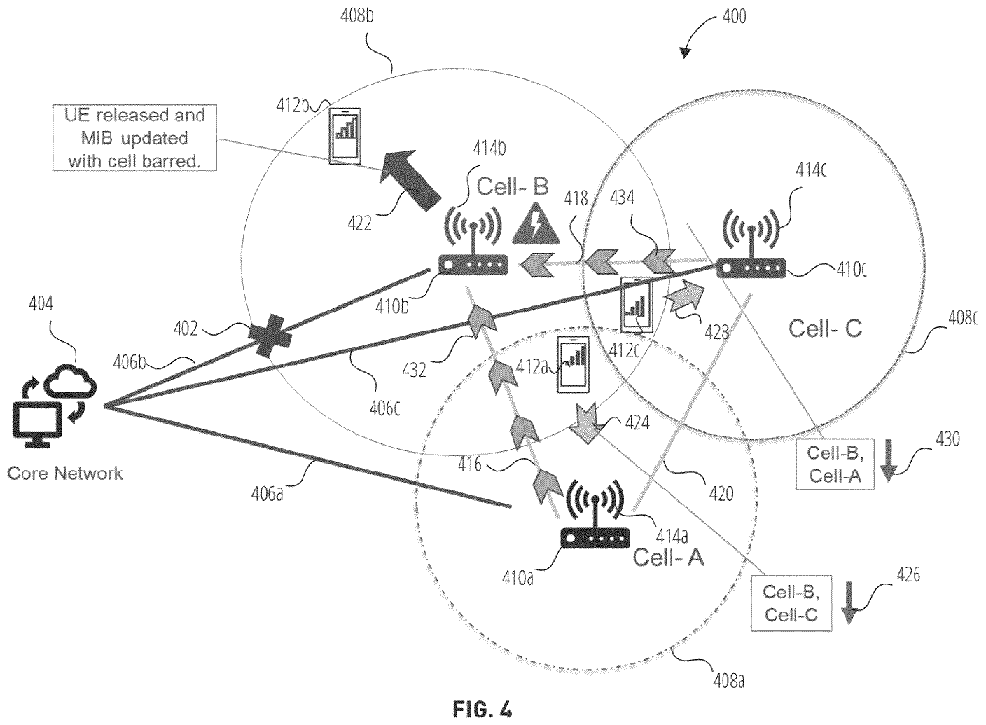

FIG. 4 shows an example of signaling in a cellular network 400 in response to a service disruption 402. Cellular network 400 includes a core network 404 with NG links 406a, 406b, and 406c to, respectively, Cell-A 408a, a Cell-B 408b, a Cell-C 408c. Each cell includes a RAN, shown as a gNB 410a, a gNB 410b, and a gNB 410c serving, respectively, a UE 412a, a UE 412b, and a UE 412c. Each RAN provides an associated SSB, such as SSB_{REF} 414a, SSB_{REF} 414b, and SSB_{REF} 414c. Xn link 416 is the interfaces between gNB 410a and gNB 410b. Xn link 418 is the interface between gNB 410b and gNB 410c. And an Xn link 420 is the interface between gNB 410c and gNB 410a.

As shown in FIG. 4, UE 412a and UE 412c are also within coverage of Cell-B 408b. As gNB 410b experiences a service disruption 402 towards core network 404, such that NG link 406b is down, gNB 410b releases UE 412b from Cell-B 408b and starts broadcasting cell barred in a MIB 422.

In the connected state, a gNB through signaling message informs a UE where to measure the other cells when the quality of the camped cell decreases. UE 412a generates a measurement report 424 received by Cell-A 408a. In measurement report 424, Cell-B 408b has a cell priority 426 that is higher than that of Cell-C 408c. This is because Cell-B 408b is still providing better radio conditions, even though there is an outage. Likewise, UE 412c generates a measurement report 428 for gNB 410c that indicates Cell-B 408b has a cell priority 430 that is higher than that of Cell-A 408a.

In response to these measurement reports 424 and 428, gNB 410a triggers an Xn handover request 432 with gNB 410b, and gNB 410c triggers an Xn handover request 434 with gNB 410b. For instance, UE 412a is moving toward Cell-B 408b, so its measurement report 424 show improving radio conditions for gNB 410b, which causes Xn handover request 432. Likewise, UE 412c is moving toward Cell-B 408b, which causes Xn handover request 434. Xn handover requests 432 and 434 will fail due to service disruption 402. For instance, in cases where gNB 410b is serving both NSA and SA UE(s) and connectivity to the AMF goes down, attempts to keep Cell-B 408b up by broadcasting MIB 422 (SSB) to continue NSA service causes the SA service UE in neighbor cells to report the affected cell for handover, which could lead to increased handover failures and degraded mobility KPI. Bringing down or stopping Cell-B 408b impacts the NSA operation in a concurrent SA/NSA case. Also, once the intermittent failure recovers, the cell bring-up takes a few minutes, which affects the overall service downtime.

Another option is to not stop Cell-B 408b but instead send a gNB configuration update message to the neighbor gNBs to delete this cell from their neighbor list. In this option, if the backhaul connection to core network 404 is down, then the neighbor gNB would also most likely be unreachable on Xn. Additionally, in case of network scanning procedure (if Network Monitoring Mode support is available) especially for small cells, neighbor gNBs can scan this neighbor and add it in their neighbor list and initiate signaling procedures to discover and connect to the affected cell, which could fail and also lead to unnecessary signaling on the backhaul.

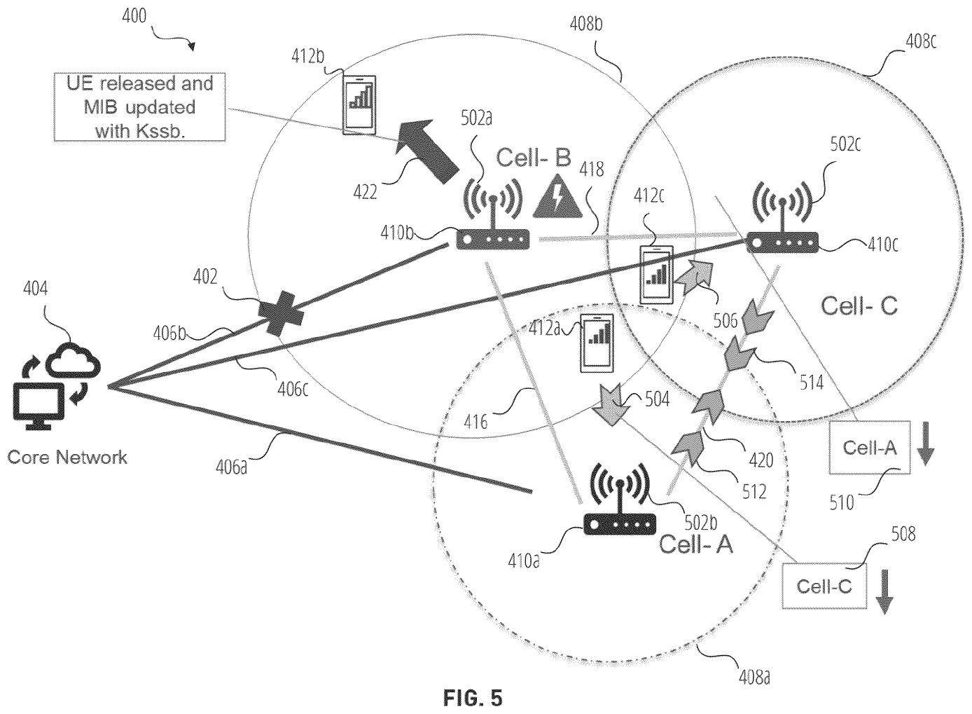

FIG. 5 also shows cellular network 400 while also implementing a technique to reduce downtime and signaling. For small cell deployments with potential short-duration SA-service only failure, when gNB 410b toward core network 404 is down, it releases UE 412b from Cell-B 408b, stops broadcasting the SIB1, and starts broadcasting a changed Kssb in MIB 422. It also shifts the location of the SSB. These steps are explained as follows.

As mentioned above, gNB 410b stops broadcasting SIB1 (though continues to broadcast MIB/SSB). This avoids providing SA service for any new SA devices, preventing them from latching onto the affected cell.

The change in the ssb-SubcarrierOffset (Kssb) in MIB 422 indicates the absence of SIB1 so that SA devices do not latch onto the affected cell. If there were no update to Kssb, then the UEs would try to search the SIB1 because Kssb information tells UE where to search for SIB1. When a particular value of Kssb value is set (31 for FR1 and 15 for FR2), that value indicates to the UEs to not search for SIB1, which is not being broadcasted. It is unnecessary to broadcast a SIB1 when the MIB has the Kssb value changed to indicate that the SIB1 is not being broadcasted.

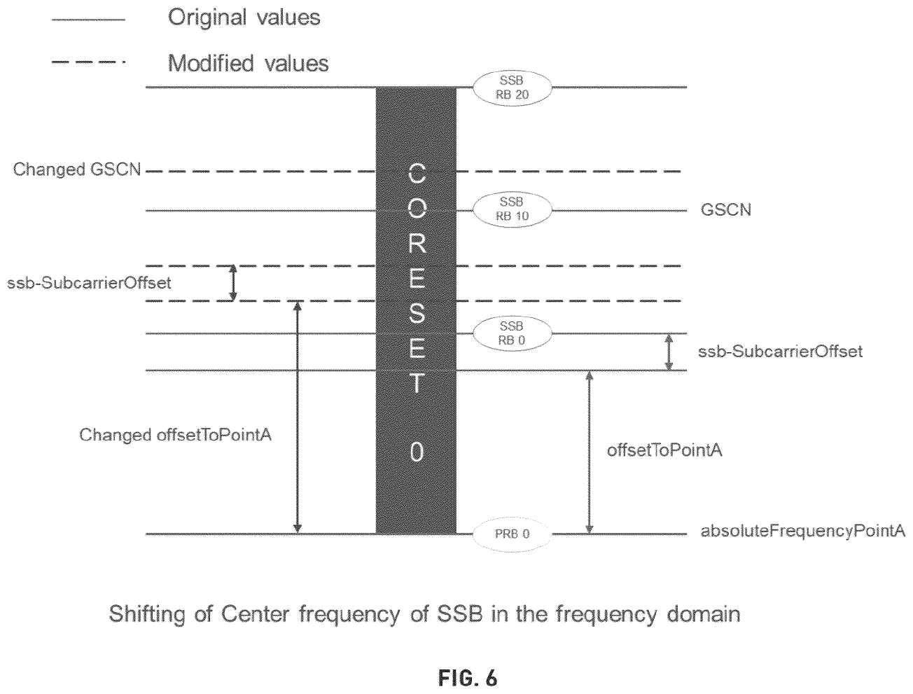

Furthermore, gNB 410b changes position of SSB_{REF} 502a. Examples of a changed SSB are shown and described later with reference to FIG. 6-FIG. 9B. UE 412a of Cell-A 408a and UE 412c of Cell-C 408c are unable to see Cell-B 408b as the position of SSB_{REF} 502a has changed (see, e.g., measurement reports 504 and 506 with only one cell priority 508 and 510). In this example, Cell-B 408b no longer registers in measurement reports 504 and 506. As UE 412a moves away from Cell-A 408a, and UE 412c moves away from Cell-C 408c, each UE indicates it has found a better cell than the current cell on which it is currently connected, Accordingly, gNB 410a generate a handover request 512. Likewise, gNB 410c generates a handover request 514. For instance, through handover request 512, gNB 410a indicates to gNB 410c that UE 412a would like to move to Cell-C 408c, and hence gNB 410c should prepare cell for it.

Shifting the location of SS/PBCH in one or both time and frequency domains avoids the need to signal the deletion of the affected cell to neighboring gNBs. This approach not only eliminates both Xn and AS signaling overhead but also works in cases where the fault condition (e.g., affected backhaul) also impacts Xn connectivity. Control to change the frequency domain or time domain location can be exercised by the gNB itself or (for an O-RAN compliant solution) in a near-real-time RIC. The following table shows how different devices respond.

| Category of device | Behavior of device | Explanation |
|---|---|---|
| NSA UE | Will work on new | gNB will report the updated |
| | shifted global | MTC (as per shifted GSCN) |
| | synchronization | information over the X2 link to |
| | channel number | the MeNB |
| | (GSCN) | |
| SA UE Idle mode | Will not latch to | Transmitted MIB will indicate |
| | the cell | unaligned location of SIB1 |
| SA UE latched to | Fail to detect the | Will try to search for MIB in the |
| neighbor gNB, Xn | cell | old GSCN location and will not |
| link exists with | | find it |
| neighbor gNB | | |
| SA UE latched to | Fail to detect the | Will try to search for MIB in the |
| neighbor gNB, Xn | cell | old GSCN location and will not |
| link does not exist | | find it |
| with neighbor gNB | | |
| Network | Will detect the | Kssb value will be set to 31 for |
| Monitoring Mode | MIB but not able | FR1 and 15 for FR2 |
| in gNB | to detect the SIB1 | |

The table above shows there is no 5G service downtime for NSA UEs. SA UEs, which are served by neighboring gNBs and are already configured with measurements for the affected gNB, will not be able to report the affected cell as a handover target because the frequency or time location of the SS/PBCH has shifted.

Upon recovery from the intermittent failure, either the SS/PBCH frequency/time location of the cell is reverted, or the neighboring gNBs and peer MeNBs are informed of the new SS/PBCH location.

Altogether, the solution allows for the continuation of NSA service in case of intermittent failures affecting SA service, reducing service downtime as reverting to the older Kssb and SSB location and starting to broadcast other SIBs (RMSI, OSI) can be done within a few seconds after fault recovery.

As indicated in FIG. 5, the position of SS/PBCH in frequency domain is changed, due to which UEs will be unable to measure the SS/PBCH since the UEs are expecting the SS/PBCH at different center frequency as per the previously complete measurement configuration. This prevents the neighbors of the affected gNB from triggering handovers towards the affected gNB.

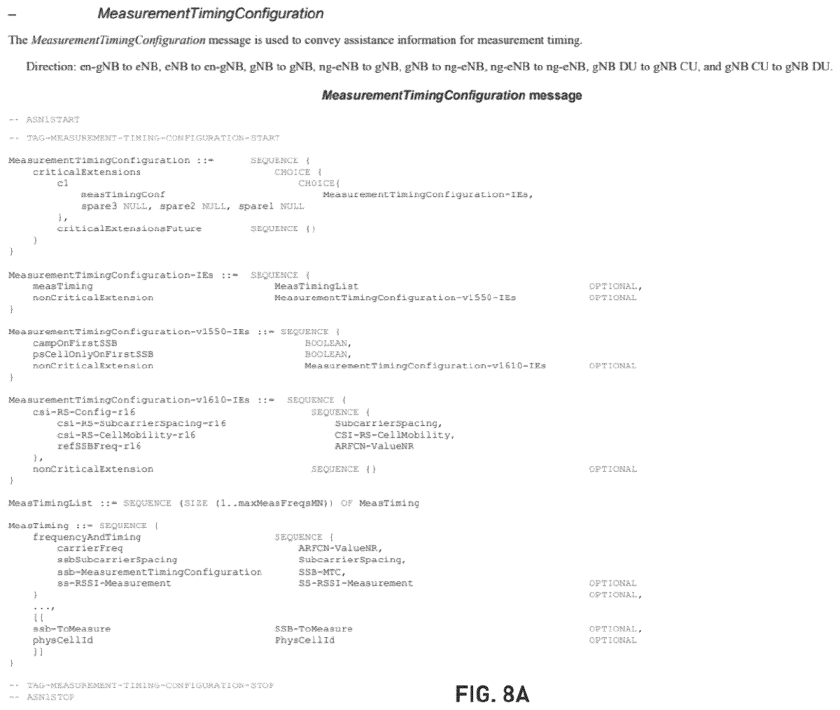

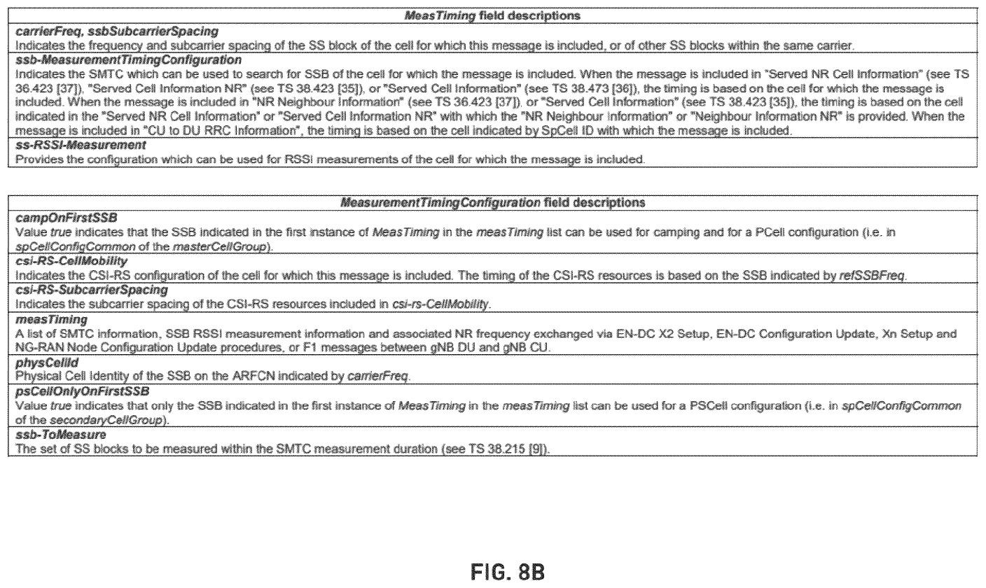

FIG. 6 shows an example of shifting a center frequency of SSB_{REF} 502b (FIG. 5) to control the incoming handovers to the affected 5G small sell from its neighboring gNBs. This parameter is L1-specific and can change from L1 vendor to vendor. This is internal and is not broadcasted to UEs. Changed GSCN is the value that is converted to ARFCN and is signaled as carrierFreq (see, e.g., carrierFreq in MeasTiming, FIG. 8A1 and FIG. 8A2 and FIG. 8B) to UE. 3GPP TS 38.331 also specifies offsetToPointA and ssb-SubcarrierOffset, which are dependent parameters that change depending upon the position of GSCN. For instance, these specify the relative position (offset) within the Physical Resource Block (PRB) from which the SSB lowest RB starts. If the GSCN changes, then the center frequency of SSB changes and it can move in upward or in downward direction in frequency domain, so it may be possible that offset within the PRB may change. 15 and 31 are special values which signifies there is no SIB1 to be read by UE.

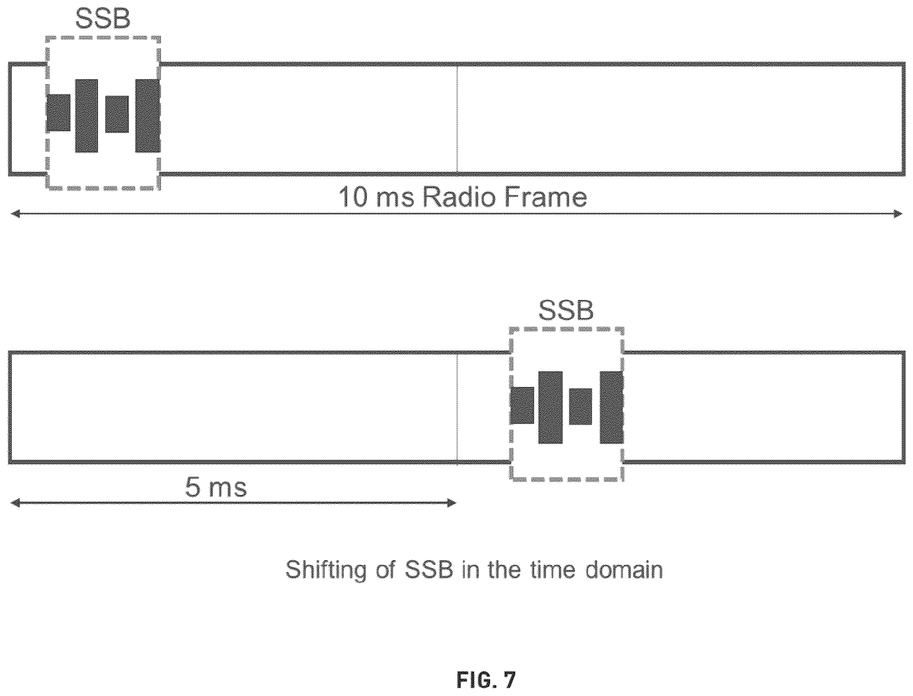

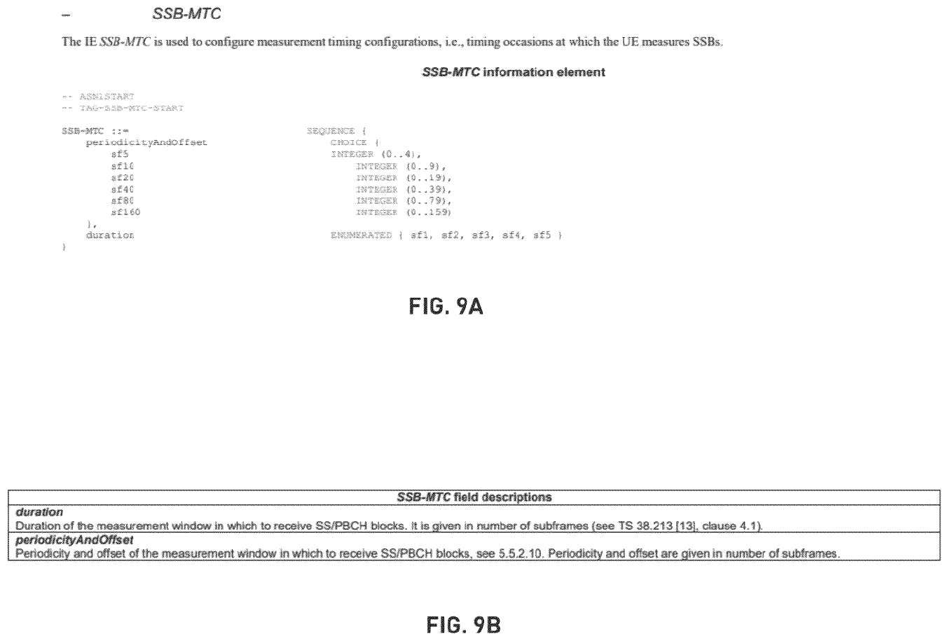

FIG. 7 shows an example of shifting SSB_{REF} 502b (FIG. 5) in the time domain to control the incoming handovers to the affected 5G small cell from its neighboring gNBs. For instance, if SSB_{REF} 502b is being broadcasted in first half of the radio frame, then it can be shifted in the second half of the radio frame and vice versa. To move the SSB to the second half of the radio frame, the SSB-MTC periodicity AndOffset parameter (see, e.g., ssb-MeasurementTimingConfiguration, FIG. 8A1 and FIG. A2 and FIG. 8B, and SSB-MTC, FIG. 9A and FIG. 9B) is changed such that the NSA UE is able to locate and measure the moved SSB. Due to this reason, the ENDC CONFIGURATION UPDATE message is sent to MeNB as described in the following figures.

FIG. 8A1 and FIG. 8A2 and FIG. 8B show the ASN for MeasurementTimingConfiguration, which includes the MeasTiming IE. In the IE, carrierFreq is an instance of the field ARFCN-ValueNR, and these two names are treated as synonyms in this disclosure. Likewise, ssb-MeasurementTimingConfiguration is an instance of the field SSB-MTC (shown in FIG. 9A and FIG. 9B), so these names are also treated as synonyms.

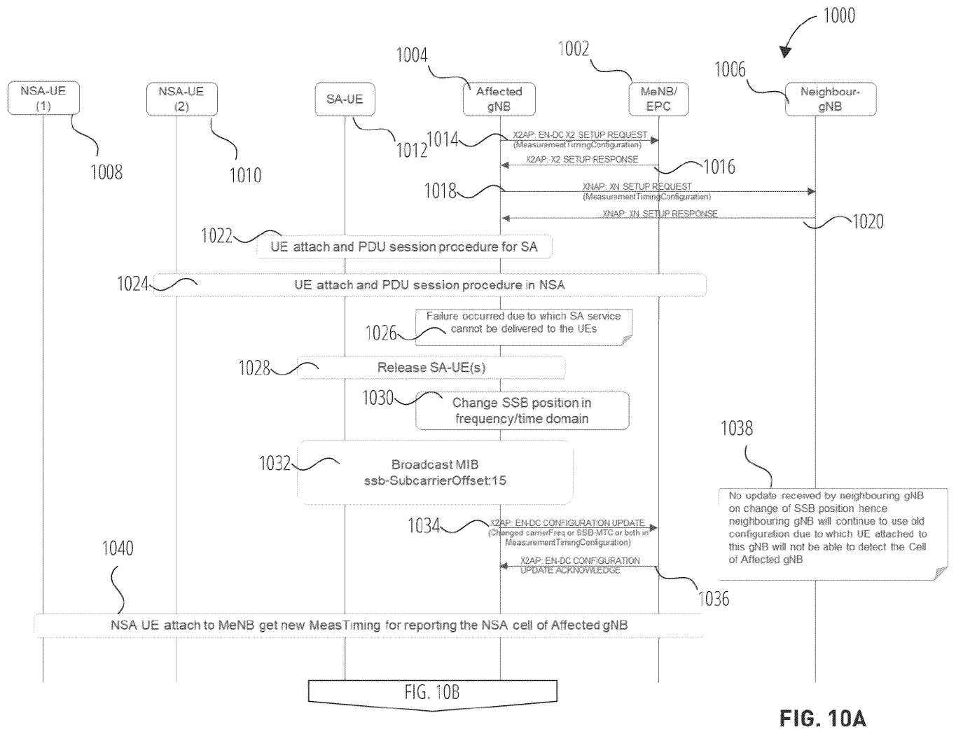

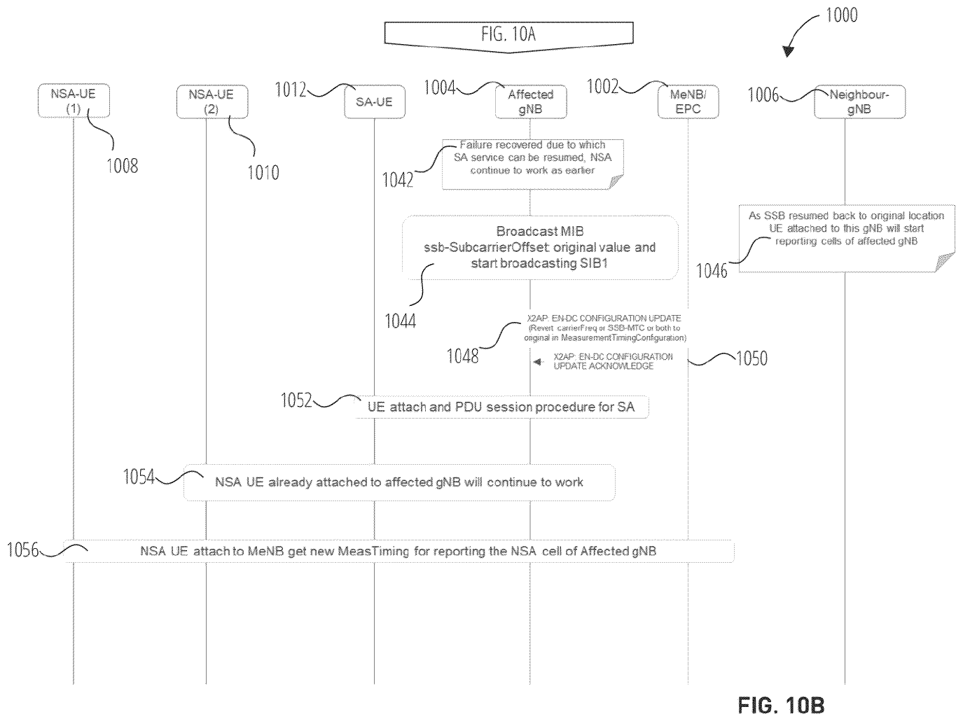

FIG. 10A shows a process 1000 performed in an NSA cellular network architecture for reducing signaling in the event a gNB experiences a loss in connectivity. In this example, the NSA cellular network architecture includes a MeNB/EPC 1002, an affected gNB 1004, and a neighbor gNB 1006. There are also three users including a first NSA-UE 1008, a second NSA-UE 1010, and an SA-UE 1012.

Initially, affected gNB 1004, uses the X2 application protocol (X2AP) and triggers an EN-DC X2 setup request message 1014. This message includes an MTC message to convey assistance information for measurement timing. In response, MeNB/EPC 1002 triggers an X2 setup response message 1016.

Similarly, affected gNB 1004, uses the XN application protocol (XNAP) and triggers an XN setup request 1018. This message also includes an MTC message. In response, neighbor gNB 1006 triggers an XN setup response 1020.

Next, SA-UE 1012 performs a UE attach and PDU session procedure 1022 with affected gNB 1004. This establishes network connectivity with SA-UE 1012. Likewise, second NSA-UE 1010 performs a UE attach and PDU session procedure 1024 with affected gNB 1004 and MeNB/EPC 1002.

In this example, affected gNB 1004 eventually has a network connectivity failure 1026 resulting in a service outage for SA-UE 1012. Thus, affected gNB 1004 proceeds to release SA-UE(s) 1028. Furthermore, affected gNB 1004 configures a change of SSB position in one or both time and frequency domains 1030. Affected gNB 1004 then will not broadcast SIB1 but it will broadcast MIB 1032. In this example, the MIB has an ssb-SubcarrierOffset value of 15 for FR2 (31 in case of FR1).

To update MeNB/EPC 1002, affected gNB 1004 triggers an EN-DC configuration update message 1034. Message 1034 indicates a change in one or both carrierFreq and SSB-MTC parameters in the MTC. In response, MeNB/EPC 1002 triggers an EN-DC configuration update acknowledge message 1036.

Neighbor gNB 1006 does not receive an update as to the change in the SSB position. As a result, it continues 1038 to use the previous configuration such that UEs attached to this gNB 1006 do not detect the cell of affected gNB 1004. This means that gNB 1004 will continue to configure UEs being attached to it with the information of MTC shared in XN setup request 1018. Hence, all UEs will monitor on the location provided in the MTC to report the measurement. Now, because the location of the SSB is repositioned, a UE will not be able to measure on the location configured by neighbor gNB 1006, and they will not send the measurement, in which case the handover will not be triggered. MTC information is signaled to UE whenever gNB configure measurement on the UE.

Finally, FIG. 10A shows that first NSA-UE 1008 attaches 1040 to MeNB/EPC 1002 to receive new MeasTiming for reporting the NSA cell of affected gNB 1004. By changing the SSB position, this avoids SA UEs to search for the affected cell. MeasurementTimingConfiguration is the IE that contains the information where SSB are being transmitted. For NSA UE to measure SA cell, the MeNB is informed how to configure NSA UE for measurement so that they can report affected cell to get the NSA service.

FIG. 10B shows process 1000 after affected gNB 1004 has recovered 1042 from its service outage. Accordingly, SA service can be resumed, and NSA continues to work as earlier. Affected gNB 1004 can resume to broadcast MIB 1044 using the original value for ssb-SubcarrierOffset. It also broadcasts SIB1. Since SSB transmission is resumed 1046, UE(s) attached to neighbor gNB 1006 can once again start reporting measurement reports for cells of affected gNB 1004.

Because affected gNB 1004 has reverted back to its previous ssb-SubcarrierOffset, it triggers an EN-DC configuration update messages 1048 to MeNB/EPC 1002. This message 1048 provides one or both carrierFreq and SSB-MTC in the MTC. In response, MeNB/EPC 1002 provides an EN-DC configuration update acknowledge message 1050.

With affected gNB 1004 restored, SA-UE 1012 can then perform a UE attach and PDU session procedure 1052. Second NSA-UE 1010 is already attached 1054. And first NSA-UE 1008 attaches 1056 to MeNB/EPC 1002 to receive new MeasTiming for reporting the NSA cell of affected gNB 1004.

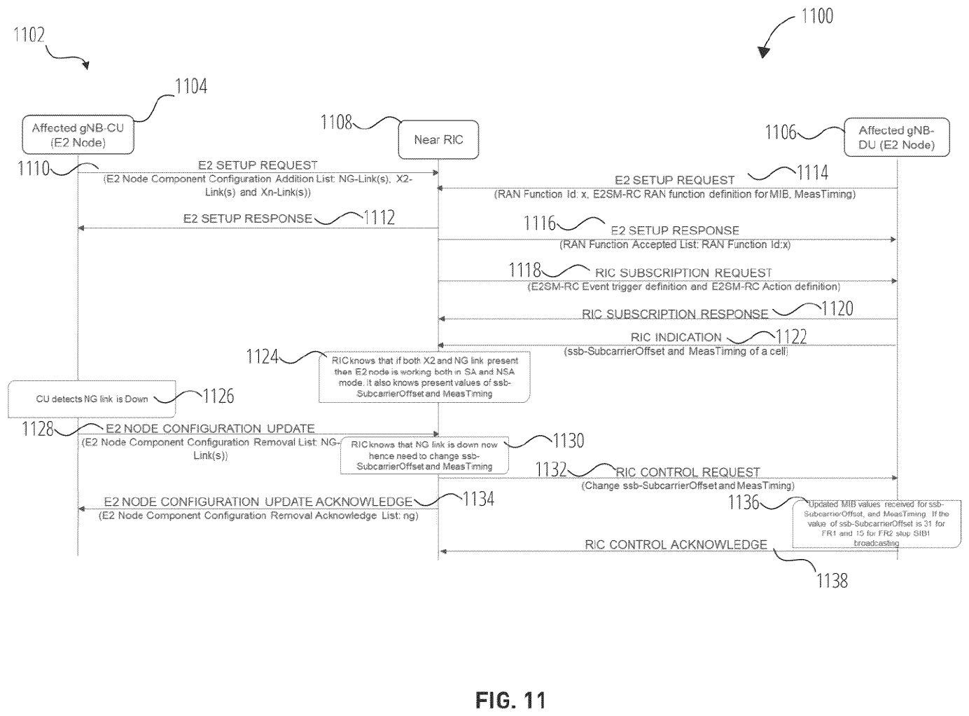

FIG. 11 shows a process 1100, performed by a gNB 1102 (including a gNB-CU 1104, a gNB-DU 1106, and a near-RT RIC 1108), for handling a service outage using signaling over an E2 interface.

Initially, gNB-CU 1104 triggers an E2 setup request message 1110 to near-RT RIC 1108. E2 setup request message 1110 includes an E2 node component configuration addition list for NG, X2, and Xn links. In response, near-RT RIC 1108 provides an E2 setup response message 1112.

Similarly, gNB-DU 1106 triggers an E2 setup request message 1114 to near-RT RIC 1108. E2 setup request message 1114 includes a RAN function ID information, E2SM-RC RAN function definition for MIB, and MeasTiming. In response, near-RT RIC 1108 provides an E2 setup response message 1116 that has a RAN function accepted list with the corresponding RAN function ID value.

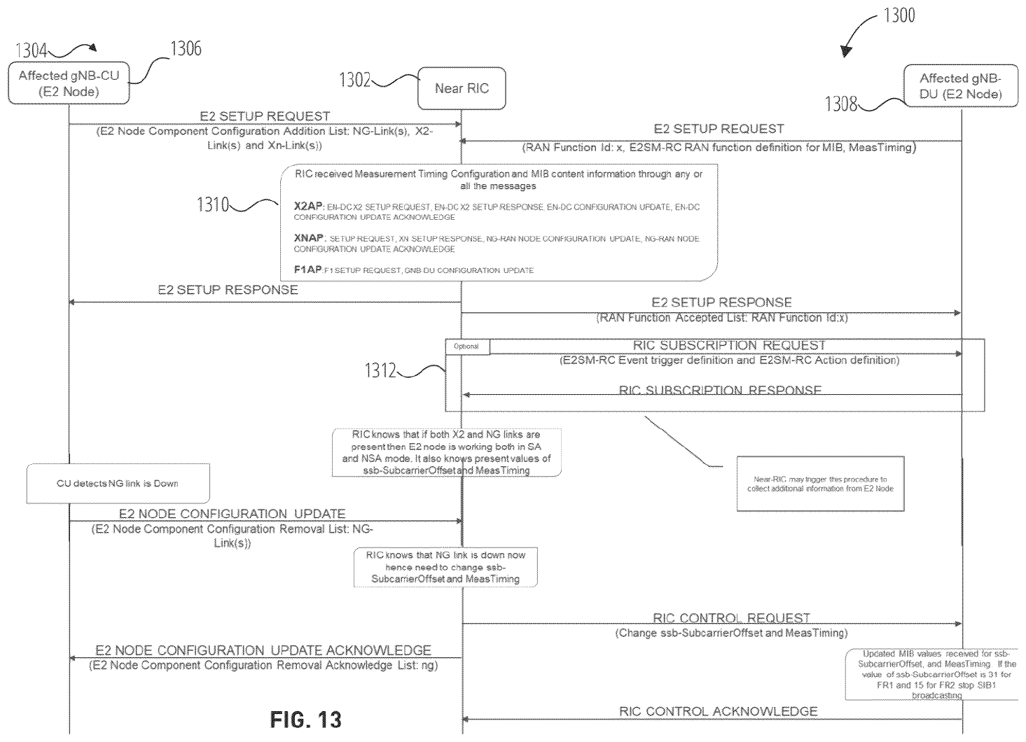

Next, near-RT RIC 1108 triggers an RIC subscription request message 1118 to collect information about the MeasurementTimingConfiguration. In this example, near-RT RIC 1108 need not used the content of the XNAP/F1AP/X2AP (c.f., FIG. 13). RIC subscription request message 1118 includes an E2SM-RC event trigger definition and E2SM-RC action definition. In response, gNB-DU 1106 triggers an RIC subscription response 1120 and an RIC indication 1122. RIC indication 1122 includes an ssb-SubcarrierOffset and MeasTiming of an associated cell for gNB-DU 1106.

Near-RT RIC 1108 has a state 1124 in which it knows that if both X2 and NG links are present, then an E2 node is working both in SA and NSA mode. It also knows present values of ssb-SubcarrierOffset and MeasTiming.

When there is a service outage, gNB-CU 1104 detects 1126 that the NG link is down. Accordingly, gNB-CU 1104 triggers an E2 node configuration update message 1128 to near-RT RIC 1108. E2 node configuration update message 1128 includes an E2 node component configuration removal list with the associated NG link(s).

At this point, near-RT RIC 1108 has a state 1130 in which it knows that there is a service outage. Thus, it begins to initiate the change in ssb-SubcarrierOffset and MeasTiming. It does so by triggering an RIC control request messages 1132 to gNB-DU 1106. It also triggers an E2 node configuration update acknowledge messages 1134 to gNB-CU 1104 so as to acknowledge the removal.

In response to RIC control request message 1132, gNB-DU 1106 has updated MIB values 1136 received for ssb-SubcarrierOffset and MeasTiming. If the value of ssb-SubcarrierOffset is 31 for FR1 and 15 for FR2, gNB-DU 1106 will stop SIB1 broadcasting. Finally, gNB-DU 1106 will trigger an RIC control acknowledge message 1138.

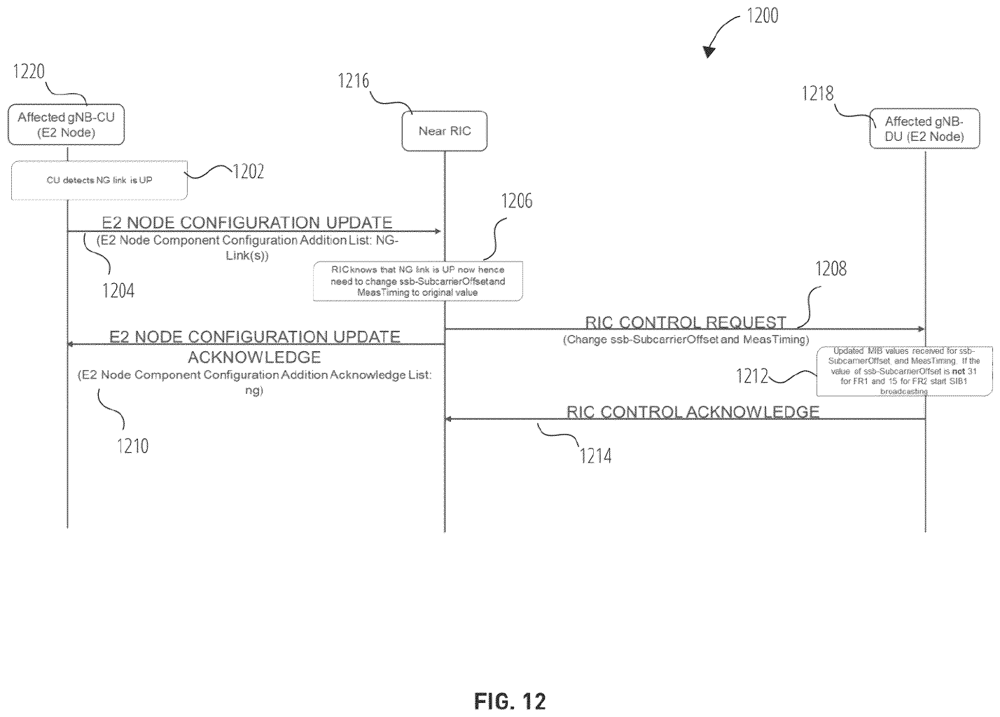

FIG. 12 shows a process 1200 that includes signaling for recovery of a service outage. To start the recovery, a gNB-CU 1220 detects 1202 the NG link is up. It therefore triggers an E2 node configuration update message 1204 to a near-RT RIC 1216. E2 node configuration update message 1204 includes an E2 node component configuration addition list indicating the NG link that is now recovered. Near-RT RIC 1216 now has a state 1206 in which it knows that the NG link is up, so it changes the ssb-SubcarrierOffset and MeasTiming to the original values.

Near-RT RIC 1216 then triggers an RIC control request message 1208 to a gNB-DU 1218 and an E2 node configuration update acknowledge message 1210 to gNB-CU 1220. RIC control request message 1208 indicates the change in the ssb-SubcarrierOffset and MeasTiming to the original values. At this point, gNB-DU 1218 updates 1212 the MIB values based on the ssb-SubcarrierOffset and MeasTiming. If the value of the ssb-SubcarrierOffset is not 31 for FR1 and 15 for FR2 then gNB-DU 1218 can initiate SIB1 broadcasting. Finally, gNB-DU 1218 triggers an RIC control acknowledge message 1214 to near-RT RIC 1216.

FIG. 13 shows a process 1300, performed by a gNB 1304 (including a gNB-CU 1306, a gNB-DU 1308, and a near-RT RIC 1302), for handling a service outage using signaling over an E2 interface. In contrast to FIG. 11, in this example near-RT RIC 1302 uses existing message(s) 1310 received for XNAP/F1AP/X2AP to obtain the MeasurementTimingConfiguration. In this example, a subscription request procedure 1312 is optional (e.g., to obtain additional information). Thus, rather than gNB-DU 1308 sending MeasTiming of the associated cell, the information is derived from XN, X2 messages also sent by gNB-CU 1306. In absence of XN and X2 interface, near-RT RIC 1302 derives MeasTiming of the associated cell from F1AP messages sent by gNB-DU 1308.

In terms of near-RT RIC 1302 signaling for recovery of a service outage, that process is shown in FIG. 12.

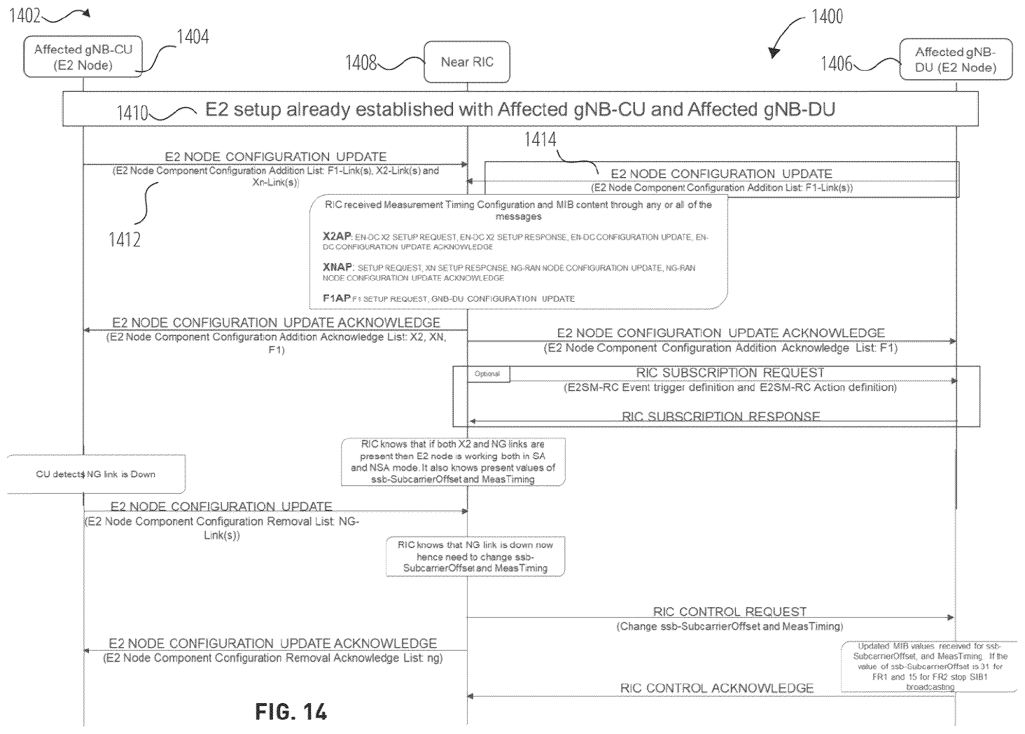

FIG. 14 shows a process 1400, performed by a gNB 1402 (including a gNB-CU 1404, a gNB-DU 1406, and a near-RT RIC 1408), for handling a service outage using signaling over an E2 interface. In contrast to FIG. 13, in this example near-RT RIC 1408 has an E2 setup 1410 that is already established with gNB-CU 1404 and gNB-DU 1406. Process 1400 is referred to as a runtime update and, instead of E2 setup request messages and responses (see, e.g., FIG. 11 and FIG. 13), it includes an E2 node configuration update 1412 from gNB-CU 1404 and an E2 node configuration update 1414 with corresponding acknowledgements. In terms of near-RT RIC 1408 signaling for recovery of a service outage, that process is shown in FIG. 12.

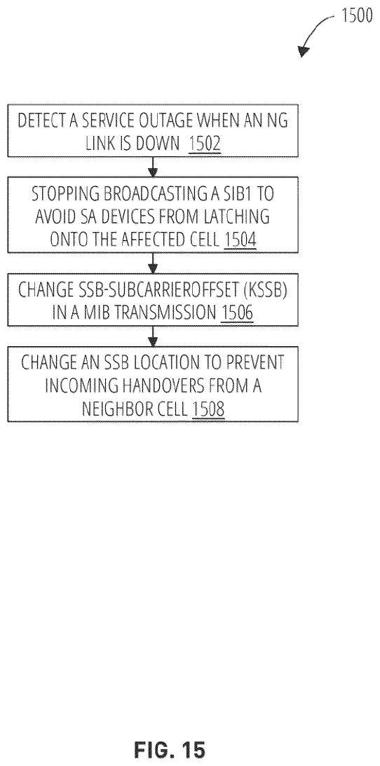

FIG. 15 shows a process 1500, performed by a gNB or O-RAN, for handling intermittent SA-service only failures. In block 1502, process 1500 detects a service outage when an NG link is down. For instance, when link goes down and peer is not reachable, then the transport layer (SCTP) gives an indication to the gNB that link is down through which the gNB derives that NG interface is down and hence cannot provide services on NG interface. In block 1504, process 1500 stopping broadcasting a SIB1 to avoid SA devices from latching onto the affected cell. In block 1506, process 1500 changes ssb-SubcarrierOffset (Kssb) in a MIB transmission. In block 1508, process 1500 changes an SSB location to prevent incoming handovers from a neighbor cell.

Process 1500 may also include releasing an SA-UE while maintaining service for an NSA-UE.

Process 1500 may also include changing the SSB location by shifting it in a frequency domain. Process 1500 may also include changing a carrierFreq parameter in a MeasurementTimingConfiguration IE.

Process 1500 may also include changing the SSB location by shifting it in a time domain. Process 1500 may also include changing an SSB-MTC parameter in a MeasurementTimingConfiguration IE.

Process 1500 may also include indicating the change in the SSB location by triggering an EN-DC configuration update message with an MeNB.

Process 1500 may also include determining that the NG link is recovered, and upon recovery, changing the SSB location to a previous location. Process 1500 may also include indicating the change in the SSB location to the previous location by triggering an EN-DC configuration update message with an MeNB. Process 1500 may also include indicating the change in the SSB location to the previous location from a near real-time RIC via an E2 interface.

Process 1500 may also include the change of the SSB location is in response to signaling from a near real-time RIC via an E2 interface.

Process 1500 may also include determining that the NG link is recovered, and upon recovery, signaling the SSB location to a neighbor gNB.

Process 1500 may also include a near-RT RIC receiving an original MeasTiming for the SSB location. Process 1500 may also include receiving the original Meas Timing in an X2AP, XNAP, or F1AP message.

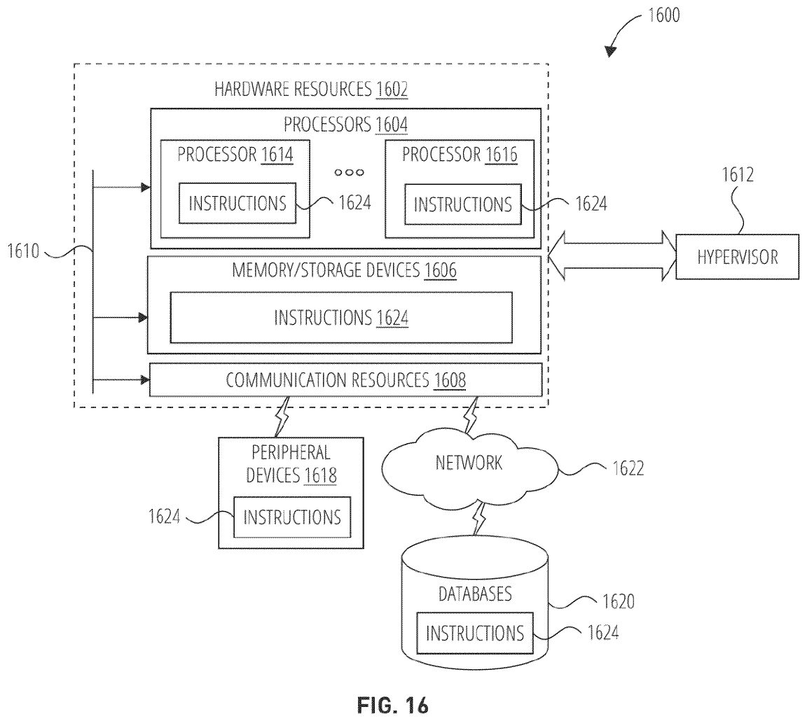

FIG. 16 is a block diagram illustrating components 1600, according to some example embodiments, that are able to read instructions from a machine-readable or computer-readable medium (e.g., a non-transitory machine-readable storage medium) and perform any one or more of the methods discussed herein, such process 1000, process 1100, process 1200, process 1300, process 1400, process 1500, or any portions of these.

Specifically, FIG. 16 shows a diagrammatic representation of hardware resources 1602 including one or more processors 1604 (or processor cores), one or more memory/storage devices 1606, and one or more communication resources 1608, each of which may be communicatively coupled via a bus 1610. For embodiments where node virtualization (e.g., NFV) is utilized, a hypervisor 1612 may be executed to provide an execution environment for one or more network slices/sub-slices to utilize hardware resources 1602.

Processors 1604 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio frequency integrated circuit (RFIC), another processor, or any suitable combination thereof) may include, for example, a processor 1614 and a processor 1616.

Memory/storage devices 1606 may include main memory, disk storage, or any suitable combination thereof. Memory/storage devices 1606 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

Communication resources 1608 may include interconnection or network interface components or other suitable devices to communicate with one or more peripheral devices 1618 or one or more databases 1620 via a network 1622. For example, communication resources 1608 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1624 may comprise software, a program, an application, an applet, an app, or other executable code for causing at least any of processors 1604 to perform any one or more of the methods discussed herein. Instructions 1624 may reside, completely or partially, within at least one of processors 1604 (e.g., within the processor's cache memory), memory/storage devices 1606, or any suitable combination thereof. Furthermore, any portion of instructions 1624 may be transferred to hardware resources 1602 from any combination of peripheral devices 1618 or databases 1620. Accordingly, the memory of processors 1604, memory/storage devices 1606, peripheral devices 1618, and databases 1620 are examples of computer-readable and machine-readable media.

In light of this disclosure, skilled persons will appreciate that many changes may be made to the details of the above-described embodiments without departing from the underlying principles of the invention. The scope of the present invention should, therefore, be determined only by claims and equivalents.

What is claimed is:

1. A method, performed by a gNB or O-RAN, for handling intermittent SA-service only failures, comprising:
detecting a service outage when an NG link is down;
stopping broadcasting a SIB1 to avoid SA devices from latching onto the affected cell;
changing ssb-SubcarrierOffset (Kssb) in a MIB transmission; and
changing an SSB location to prevent incoming handovers from a neighbor cell.

2. The method of claim 1, further comprising releasing an SA-UE while maintaining service for an NSA-UE.

3. The method of claim 1, further comprising changing the SSB location by shifting it in a frequency domain.

4. The method of claim 3, further comprising changing a carrierFreq parameter in a MeasurementTimingConfiguration IE.

5. The method of claim 1, further comprising changing the SSB location by shifting it in a time domain.

6. The method of claim 5, further comprising changing an SSB-MTC parameter in a MeasurementTimingConfiguration IE.

7. The method of claim 1, further comprising indicating the change in the SSB location by triggering an EN-DC configuration update message with an MeNB.

8. The method of claim 1, further comprising:
determining that the NG link is recovered; and
upon recovery, changing the SSB location to a previous location.

9. The method of claim 8, further comprising indicating the change in the SSB location to the previous location by triggering an EN-DC configuration update message with an MeNB.

10. The method of claim 8, further comprising indicating the change in the SSB location to the previous location from a near real-time RIC via an E2 interface.

11. The method of claim 1, in which the change of the SSB location is in response to signaling from a near real-time RIC via an E2 interface.

12. The method of claim 1, further comprising:
determining that the NG link is recovered; and
upon recovery, signaling the SSB location to a neighbor gNB.

13. The method of claim 1, in which a near-RT RIC receives an original MeasTiming for the SSB location.

14. The method of claim 13, further comprising receiving the original MeasTiming in an X2AP, XNAP, or F1AP message.
